(19) United States
(12) Patent Application Publication
(10) Pub. No.: US 2025/0253551 A1
(43) Pub. Date: Aug. 7, 2025

(54) ALIGNED INSULATION HOOKING BUSBAR

(71) Applicant: Bentek Corporation, San Jose, CA (US)

(72) Inventors: Vlatko Babic, Lafayette, LA (US); Hrishikesh Anant Marathe, Sunnyvale, CA (US); Robert Joseph Hannum, Mountain View, CA (US)

(21) Appl. No.: 19/043,096

(22) Filed: Jan. 31, 2025

Related U.S. Application Data
(60) Provisional application No. 63/549,172, filed on Feb. 2, 2024.

(51) Int. Cl. H01R 4/2406; H01R 4/2495; H01R 25/16; H01R 43/01

(52) U.S. Cl. CPC H01R 4/2406; H01R 4/2495; H01R 25/161; H01R 43/01

(57) ABSTRACT

In one or more embodiments, aligned insulation hooking busbar, and a method for providing the same are disclosed. The aligned insulation hooking busbar includes at least one connection end including one or more angled teeth, wherein the one or more angled teeth are sharp enough to pierce through an insulation part of a cable including the insulation part and a conductor part, wherein the one or more angled teeth are structured with a skinny body and a curved tip without compromising the ability of the one or more angled teeth to pierce through the insulation part of the cable when proper force is applied, and wherein the one or more angled teeth make an electrical connection between the busbar and the conductor part of the cable when in contact with the conductor part of the cable.

### CROSS-REFERENCE TO RELATED APPLICATIONS

Under 35 USC 119 (e), this application claims priority to U.S. provisional application Ser. No. 63/549,172, filed on Feb. 2, 2024, all of which is incorporated herein by reference in its entirety.

### FIELD OF THE INVENTION

The embodiments described herein relate generally to electrical connectors and more particularly to aligned insulation hooking busbar.

### SUMMARY

In one or more embodiments, a device, aligned insulation hooking busbar, and a method for providing aligned insulation hooking busbar are disclosed.

In an embodiment, the aligned insulation hooking busbar includes at least one connection end, wherein the at least one connection end further includes one or more angled teeth, wherein the one or more angled teeth are sharp enough to pierce through an insulation part of a cable including the insulation part and a conductor part, wherein the one or more angled teeth are structured with a skinny body and a curved tip without compromising the ability of the one or more angled teeth to pierce through the insulation part of the cable when proper force is applied, and wherein the one or more angled teeth make an electrical connection between the busbar and the conductor part of the cable when in contact with the conductor part of the cable.

In an embodiment, the one or more angled teeth are capable of bending and hence facilitate bending and sliding motion underneath the surface of the insulation part without compromising the ability of the teeth to pierce through the insulation when proper force is applied.

In an embodiment, the one or more angled teeth create one or more voids in the conductor part of the cable and follow the created one or more voids until the one or more angled teeth are embedded in the conductor part of the cable, or the one or more aligned teeth slide in between the internal strands of the conducting part of the cable until they are embedded in the conductor part of the cable, or a combination thereof.

In an embodiment, the method for providing aligned insulation hooking busbar includes providing a busbar with at least one connection end; and providing one or more angled teeth at the connection end of the busbar, wherein the one or more angled teeth are sharp enough to penetrate an insulation part of a cable including the insulation part and a conductor part, wherein the one or more angled teeth are structured with a skinny body and a curved tip without compromising the ability of the teeth to pierce through the insulation when proper force is applied; and wherein the one or more angled teeth are capable of making an electrical connection between the busbar and the conductor part of the cable.

In an embodiment, the one or more angled teeth are capable of bending and hence facilitate bending and sliding motion underneath the surface of the insulation part without compromising the ability of the teeth to pierce through the insulation when proper force is applied.

In an embodiment, the wherein the one or more angled teeth create one or more voids in the conductor part of the cable and follow the created one or more voids until the one or more angled teeth are embedded in the conductor part of the cable, or the one or more aligned teeth slide in between the internal strands of the conducting part of the cable until they are embedded in the conductor part of the cable, or a combination thereof.

### BRIEF DESCRIPTION OF THE DRAWINGS

FIGS. 1A, 1B and 1C illustrate an example aligned insulation hooking busbar according to one or more embodiments described herein.

FIG. 2 illustrates an example aligned insulation hooking busbar according to one or more embodiments described herein.

FIGS. 3A, 3B and 3C illustrate an example motion of the aligned insulation hooking busbar according to one or more embodiments described herein.

FIG. 4 illustrates an example aligned insulation hooking busbar in contact with a conductor part of a cable according to one or more embodiments described herein.

FIGS. 5A, 5B and 5C illustrate an example motion of the aligned insulation hooking busbar according to one or more embodiments described herein.

FIG. 6 illustrates an example aligned insulation hooking busbar in contact with a conductor part of a cable according to one or more embodiments described herein.

FIGS. 7A, 7B and 7C illustrate different configurations of the aligned insulation hooking busbar according to one or more embodiments described herein.

FIGS. 8A, 8B and 8C illustrate example method flows 800, 800′ and 800″ for providing an aligned insulation hooking busbar according to one or more embodiments described herein.

### DETAILED DESCRIPTION

The embodiments described herein relate generally to electrical connectors and more particularly to aligned insulation hooking busbar.

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

In one or more embodiments, a device, aligned insulation hooking busbar, and a method for providing aligned insulation hooking busbar are disclosed.

In an embodiment, the aligned insulation hooking busbar includes at least one connection end, wherein the at least one connection end further includes one or more angled teeth, wherein the one or more angled teeth are sharp enough to pierce through an insulation part of a cable including the insulation part and a conductor part, wherein the one or more angled teeth are structured with a skinny body and a curved tip without compromising the ability of the one or more angled teeth to pierce through the insulation part of the cable when proper force is applied, and wherein the one or more angled teeth make an electrical connection between the busbar and the conductor part of the cable when in contact with the conductor part of the cable.

In an embodiment, the one or more angled teeth are capable of bending and hence facilitate bending and sliding motion underneath the surface of the insulation part without compromising the ability of the teeth to pierce through the insulation when proper force is applied.

In an embodiment, the one or more angled teeth create one or more voids in the conductor part of the cable and follow the created one or more voids until the one or more angled teeth are embedded in the conductor part of the cable, or the one or more aligned teeth slide in between the internal strands of the conducting part of the cable until they are embedded in the conductor part of the cable, or a combination thereof.

In an embodiment, the method for providing aligned insulation hooking busbar includes providing a busbar with at least one connection end; and providing one or more angled teeth at the connection end of the busbar, wherein the one or more angled teeth are sharp enough to penetrate an insulation part of a cable including the insulation part and a conductor part, wherein the one or more angled teeth are structured with a skinny body and a curved tip without compromising the ability of the teeth to pierce through the insulation when proper force is applied; and wherein the one or more angled teeth are capable of making an electrical connection between the busbar and the conductor part of the cable.

In an embodiment, the one or more angled teeth are capable of bending and hence facilitate bending and sliding motion underneath the surface of the insulation part without compromising the ability of the teeth to pierce through the insulation when proper force is applied.

In an embodiment, wherein the one or more angled teeth create one or more voids in the conductor part of the cable and follow the created one or more voids until the one or more angled teeth are embedded in the conductor part of the cable, or the one or more aligned teeth slide in between the internal strands of the conducting part of the cable until they are embedded in the conductor part of the cable, or a combination thereof.

The purpose of this device/system and method is to make a quick and easy connection between a busbar and a cable or a conductor portion of the cable. A person skilled in the art may readily understand that this device/method could be utilized in a multitude of indoor and/or outdoor busbar and cable connections and is within the spirit and scope of the present invention described herein.

This device/system is made up of a main body, also referred to herein as a busbar, and one or more angled teeth that pierce through the insulation part/barrier of a cable and then begin to bend underneath the insulation once the tip of the teeth contact the surface of the conductor part of the cable. In the main body, the multiple incoming power cables may be electrically and mechanically attached to a busbar which is made up of a good current carrying material. At the bottom of the busbar, there are “teeth’ or sharp pointy peaks, which will be used to pierce/penetrate the insulation of the cable. The “teeth” or sharp pointy peaks are made of material with good electrical conductivity, which may be the same as the busbar as illustrated by the accompanying figures.

This design utilizes an angled hooking style approach to cable insulation piercing teeth. The busbar uses angled teeth that pierce through the insulation part/barrier of a cable and then begin to bend underneath the insulation part of the cable once the tip of the teeth contact the surface of the conductor part of the cable. The teeth are structured with a skinny body and a curved tip capable of bending to help facilitate the bending and sliding motion underneath the surface of the insulation layer, and/or sliding between the internal strands of the cable, and/or the one or more angled teeth create one or more voids in the conductor part of the cable and follow the created one or more voids until the one or more angled teeth are embedded in the conductor part of the cable, without compromising the ability of the teeth to pierce through the insulation when proper force is applied. Overall, this method of insulation piercing aims to simulate a crimping force by aligning the teeth along the conductor part of the cable with force equivalent to thousands of pounds applied between the busbar, insulation barrier, and the conductor part of the cable itself as illustrated by the accompanying figures.

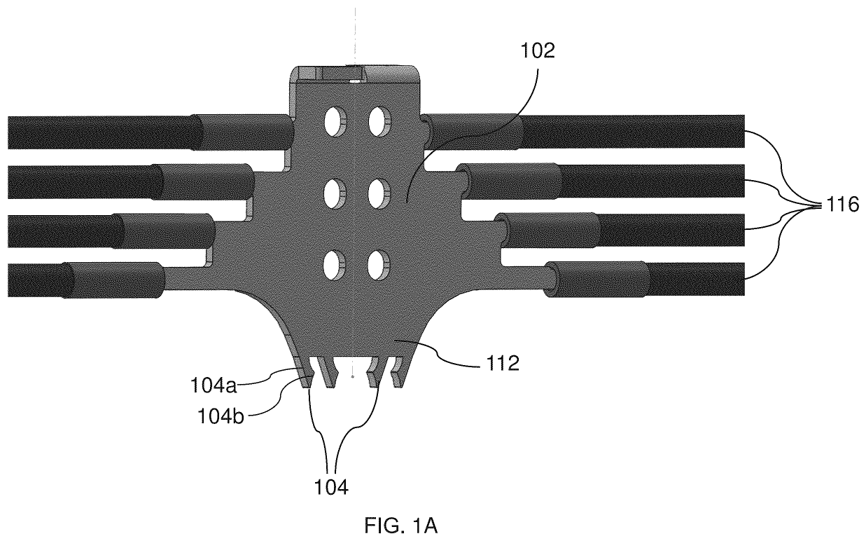

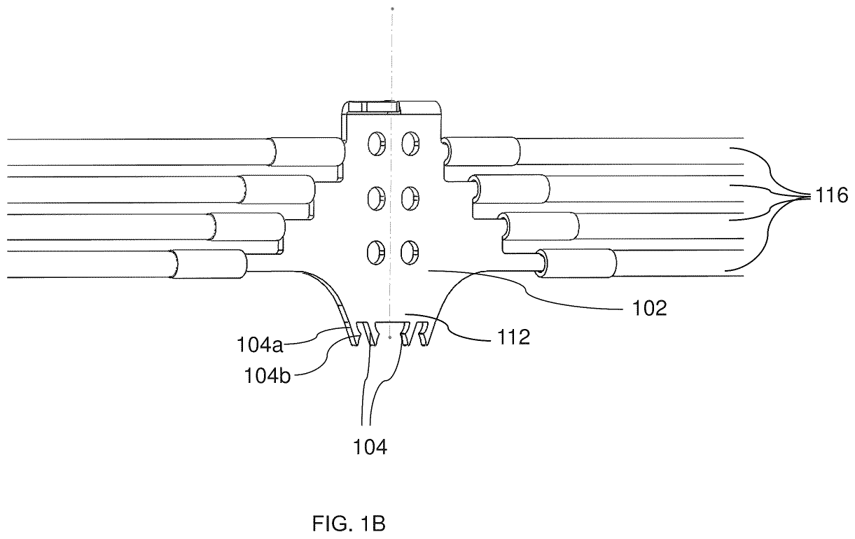

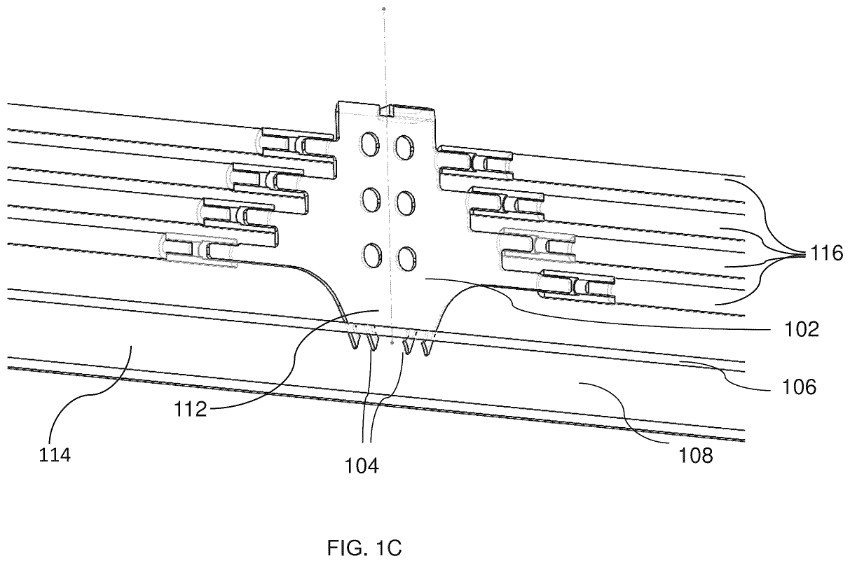

FIGS. 1A, 1B and 1C illustrate an example aligned insulation hooking busbar according to one or more embodiments described herein. For example, as illustrated in FIG. 1A, the device/system described herein is made up of a main body, also referred to herein as a busbar 102, and one or more angled teeth 104 that pierce through the insulation part/barrier 106 of a cable 114 as illustrated in FIG. 1C, and then begin to bend underneath the insulation 106 once the tip of the teeth 104 contact the surface of the conductor part 108 of the cable 114.

Additionally or alternatively, the one or more aligned teeth 104 may slide in between the internal strands of the conducting part 108 of the cable 114 until they are embedded in the conductor part of the cable.

Additionally or alternatively, the one or more aligned teeth may create one or more voids in the conductor part of the cable and follow the created one or more voids until the one or more angled teeth are embedded in the conductor part of the cable

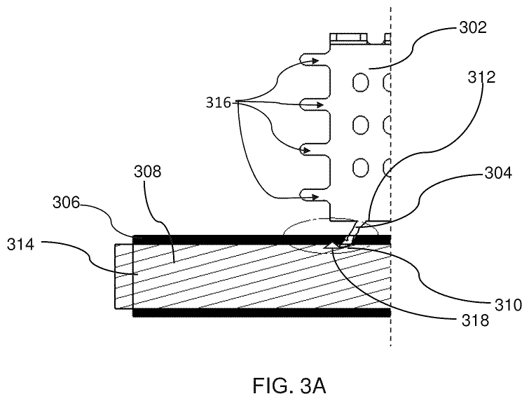

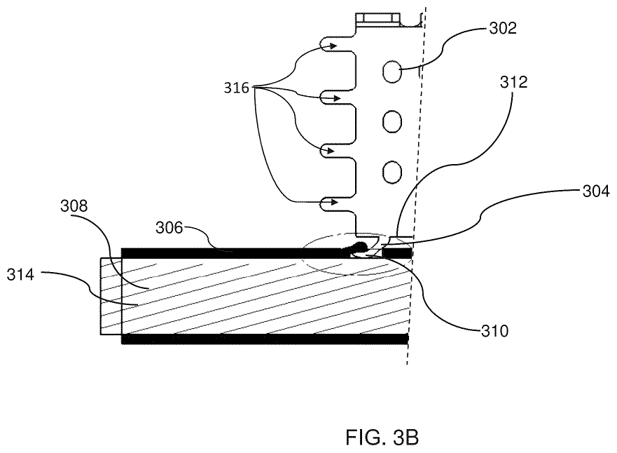

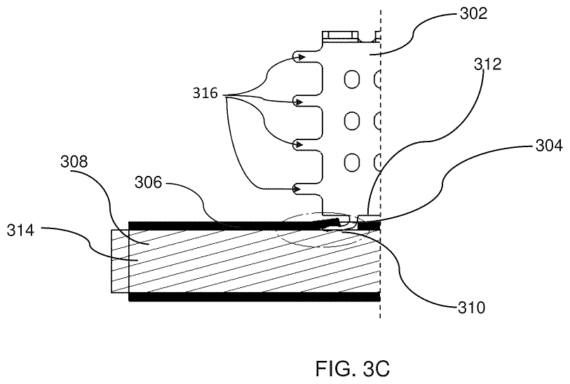

This is illustrated in FIGS. 3A-3C, 4, 5A-5C, 6 and described in detail in the description accompanying FIGS. 3A-3C, 4, 5A-5C and 6.

In the main body, the multiple incoming power cables 116 may be electrically and mechanically attached to a busbar 102 which is made up of a good current carrying material or material with good electrical conductivity. At the bottom of the busbar 102, also referred to herein as the connection end 112, there are “teeth’ or sharp pointy peaks 104, which will be used to pierce/penetrate the insulation 106 of the cable 114. The “teeth” or sharp pointy peaks 104 are made of material with good electrical conductivity, which may be the same as the busbar 102.

Although 4 incoming cables 116 are shown on each side of the busbar 102, a person skilled in the art may readily understand that more or less number of cables may be used and is within the spirit and scope of the invention.

This design of the angled teeth 104 utilizes an angled hooking style approach to cable insulation piercing teeth. The busbar 102 uses angled teeth 104 that pierce through the insulation part/barrier of a cable 106 and then begin to bend underneath the insulation part of the cable 106 once the tip of the teeth 104 contact the surface of the conductor part of the cable 108, and/or sliding between the internal strands of the conductor part of the cable 108, and/or the one or more angled teeth create one or more voids in the conductor part of the cable and follow the created one or more voids until the one or more angled teeth are embedded in the conductor part of the cable.

The teeth 104 are structured with a skinny body 104a and a curved tip 104b as illustrated in FIG. 1B capable of bending and hence facilitate the bending and sliding motion underneath the surface of the insulation layer 106 without compromising the ability of the teeth 104 to pierce through the insulation 106 when proper force is applied. Overall, this method of insulation piercing aims to simulate a crimping force by aligning the teeth 104 along the conductor part of the cable 108 with force equivalent to thousands of pounds applied between the busbar 102, insulation barrier 106, and the conductor part of the cable 108 itself.

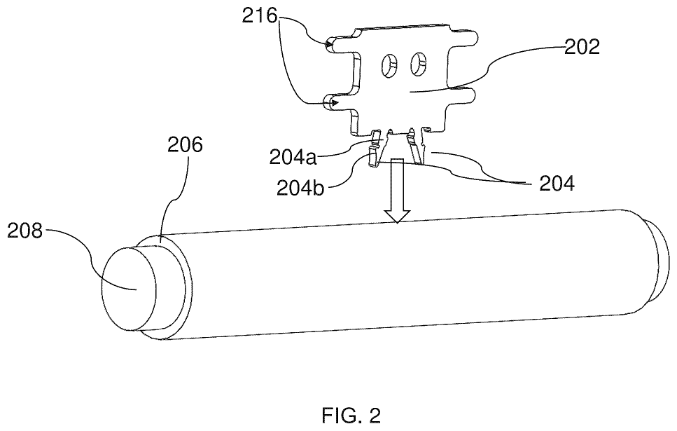

FIG. 2 illustrates an example aligned insulation hooking busbar according to one or more embodiments described herein. For example, as illustrated in FIG. 2, the device/system described herein is made up of a main body, also referred to herein as a busbar 202, and one or more angled teeth 204 that pierce through the insulation part/barrier 206 of a cable 214, and then begin to bend underneath the insulation 206 once the tip of the teeth 204 contact the surface of the conductor part 208 of the cable 214. This is illustrated in FIGS. 3A-3C and described in detail in the description accompanying FIGS. 3A-3C.

This design of the angled teeth 204 utilizes an angled hooking style approach to cable insulation piercing teeth. The busbar 202 uses angled teeth 204 that pierce through the insulation part/barrier of a cable 206 and then begin to bend underneath the insulation part of the cable 206 once the tip of the teeth 204 contact the surface of the conductor part of the cable 208 until the one or more angled teeth 204 are in contact with the conductor part of the cable 208.

Additionally or alternatively, the one or more aligned teeth 204 may slide in between the internal strands of the conducting part 208 of the cable 214 until they are embedded in the conductor part of the cable.

Additionally or alternatively, the one or more aligned teeth 204 may create one or more voids in the conductor part of the cable 208 and follow the created one or more voids until the one or more angled teeth 204 are embedded in the conductor part of the cable 208.

This is illustrated in FIGS. 3A-3C, 4, 5A-5C, 6 and described in detail in the description accompanying FIGS. 3A-3C, 4, 5A-5C and 6.

The teeth 204 are structured with a skinny body 204a and a curved tip 204b as illustrated in FIG. 2 capable of bending and hence help facilitate the bending and sliding motion underneath the surface of the insulation layer 206, and/or sliding between the internal strands of the conductor part of the cable 108, and/or creating one or more voids in the conductor part of the cable 208 and following the created one or more voids until the one or more angled teeth 204 are embedded in the conductor part of the cable 208, without compromising the ability of the teeth 204 to pierce through the insulation 206 when proper force is applied.

Overall, this method of insulation piercing aims to simulate a crimping force by aligning the teeth 204 along the conductor part of the cable 208 with force equivalent to thousands of pounds applied between the busbar 202, insulation barrier 206, and the conductor part of the cable 208 itself.

In the main body, the multiple incoming power cables 216 may be electrically and mechanically attached to a busbar 202 which is made up of a good current carrying material or material with good electrical conductivity. At the bottom of the busbar 202, also referred to herein as the connection end 212, there are “teeth’ or sharp pointy peaks 204, which will be used to pierce/penetrate the insulation 206 of the cable 214. The “teeth” or sharp pointy peaks 204 are made of material with good electrical conductivity, which may be the same as the busbar 202.

Although two incoming cables 216 are shown on each side of the busbar 102, a person skilled in the art may readily understand that more or less number of cables may be used and is within the spirit and scope of the invention.

FIGS. 3A, 3B and 3C illustrate an example motion of the aligned insulation hooking busbar according to one or more embodiments described herein. For example, FIG. 3A illustrates initial piercing motion of the aligned insulation hooking busbar shown as a partial assembly, FIG. 3B illustrates intermediate motion shown as a partial assembly showing tip deflection of the aligned insulation hooking busbar as it hits the conductor also referred to herein as a conducting part of the cable, and FIG. 3C illustrates end motion shown as a partial assembly showing sliding and conductor contact of the aligned insulation hooking busbar according to one or more embodiments described herein.

For example, as illustrated in FIG. 3A, the device/system described herein is made up of a main body, also referred to herein as a busbar 302, and one or more angled teeth 304 that pierce through the insulation part/barrier 306 of a cable 314. Due to this piercing motion, the insulation part next to the point of piercing may be lifted up creating a gap 318 for the piercing teeth to begin to bend underneath the insulation 306 as illustrated in FIG. 3B. Once the tip of the teeth 304 contact the surface of the conductor part 308 of the cable 314 they form a contact 310 between the teeth 304 and the conductor part 308 of the cable 314.

Once the piercing process is complete, the insulation part of the cable 306 may retract back in the original position creating a seal as illustrated in FIG. 3C, enclosing the assembly including the contact 310 formed between the angled piercing teeth 304 and the conductor part of the cable 308.

In the main body, the multiple incoming power cables 316 may be electrically and mechanically attached to a busbar 302 which is made up of a good current carrying material or material with good electrical conductivity. At the bottom of the busbar 302, also referred to herein as the connection end 312, there are “teeth” or sharp pointy peaks 304, which will be used to pierce/penetrate the insulation 306 of the cable 314. The “teeth” or sharp pointy peaks 304 are made of material with good electrical conductivity, which may be the same as the busbar 302.

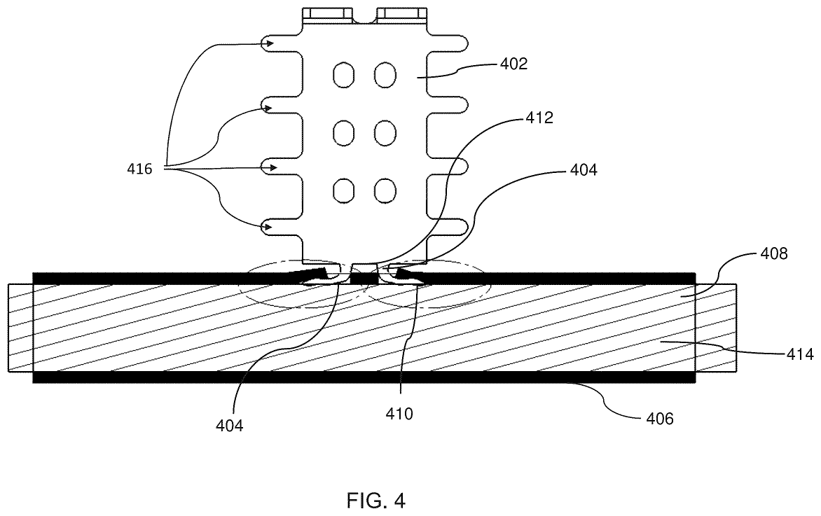

FIG. 4 illustrates an example aligned insulation hooking busbar in contact with a conductor part of a cable according to one or more embodiments described herein. For example, FIG. 4 illustrates the aligned insulation hooking busbar 402 including at least one connection end 412, wherein the at least one connection end further includes one or more angled teeth 404, wherein the one or more angled teeth 404 are sharp enough to pierce through an insulation part 406 of a cable 414 including the insulation part 406 and a conductor part 408, wherein the one or more angled teeth 404 are structured with a skinny body and a curved tip capable of bending and hence facilitate bending and sliding motion underneath the insulation part 406 of the cable 414 without compromising the ability of the one or more angled teeth 404 to pierce through the insulation part 406 of the cable 414 when proper force is applied, and wherein the one or more angled teeth 404 make an electrical connection between the busbar 402 and the conductor part 408 of the cable 414 when in contact 410 with the conductor part 408 of the cable 414.

In the main body, the multiple incoming power cables 416 may be electrically and mechanically attached to the busbar 402 which is made up of a good current carrying material or material with good electrical conductivity and is provided with one or more angled teeth 404.

Although, FIG. 4 illustrates internal strands of the conductor part of the cable as twisted, they may be straight as commercially the cables may be available in different configurations, and is also within the spirit and scope of the invention.

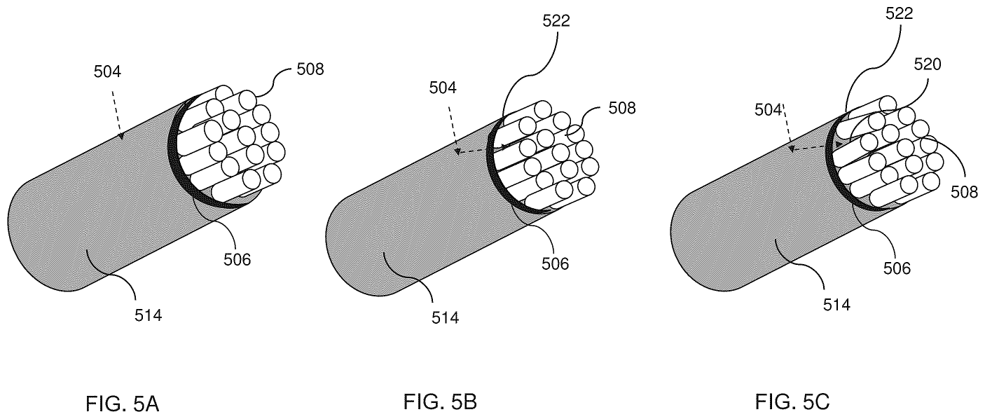

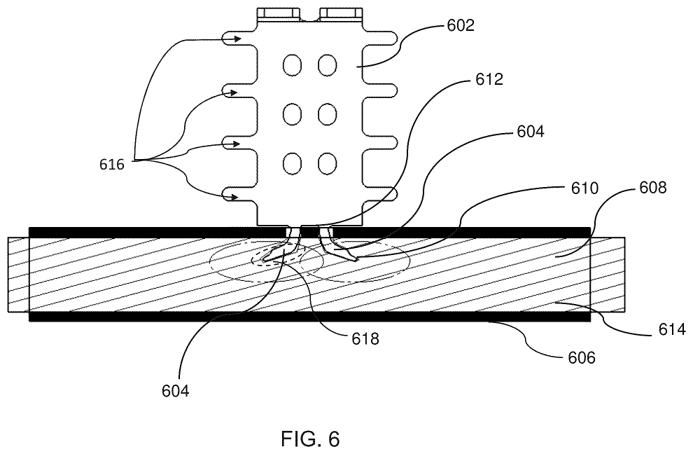

FIGS. 5A, 5B and 5C illustrate an example motion of the aligned insulation hooking busbar according to one or more embodiments described herein. For example, FIG. 5A illustrates initial piercing motion of the aligned insulation hooking busbar through insulation part 506 of the cable 514, FIG. 5B illustrates tip deflection of the aligned insulation hooking busbar as it hits the conductor also referred to herein as a conducting part of the cable, and FIG. 5C illustrates sliding between the internal strands of the conductor part of the cable 508, and/or creating one or more voids 520 in the conductor part of the cable 508 and following the created one or more voids 520 until the one or more angled teeth 504 are embedded in the conductor part of the cable 508, and forming conductor contact 618 of the aligned insulation hooking busbar 602 with the conducting part of the cable 608 as illustrated in FIG. 6, according to one or more embodiments described herein.

Although, FIGS. 5A-5C illustrate internal strands of the conductor part of the cable as straight, they may be twisted as commercially the cables may be available in different configurations, and is also within the spirit and scope of the invention.

FIG. 6 illustrates an example aligned insulation hooking busbar in contact with a conductor part of a cable 608 according to one or more embodiments described herein. For example, in one or more embodiments described herein, in the main body, the multiple incoming power cables 616 may be electrically and mechanically attached to a busbar 602 which is made up of a good current carrying material or material with good electrical conductivity and is provided with one or more angled teeth 604. The conducting part of the cable 608 may be made of multiple conductive strands are held together, for example, wound around each other in a twisted manner, as illustrated in FIG. 6, or straight as illustrated in FIGS. 5A-5C, compressed and/or covered by the insulation 606. When the angled teeth 604 pierce through the insulation part of the cable 606 and push in the conducting part of the cable 608, the multiple conductive strands within the conducting part of the cable 608 deflect creating voids or grooves 520 as illustrated in FIG. 5C, until they are embedded in the conductor part of the cable.

Additionally or alternatively, the one or more aligned teeth may slide in between the internal strands of the conducting part 508 of the cable 514, which is illustrated as 522, as illustrated in FIGS. 5B and 5C until they are embedded in the conductor part 508 of the cable 514.

As illustrated in FIG. 6, the angled teeth 604 of the hooking busbar 602 create voids or spaces 618 between the stranding of the main conductor part of the cable 608 as they pierce through the insulation part of the cable 606 and follow those voids 618 until they are completely embedded in the stranding of the conductor part of the cable 608, and/or the one or more aligned teeth slide in between 522 the internal strands of the conducting part of the cable as illustrated in FIGS. 5B and 5C until they are embedded in the conductor part of the cable.

For example, FIG. 6 illustrates the aligned insulation hooking busbar 602 including at least one connection end 612, wherein the at least one connection end further includes one or more angled teeth 604, wherein the one or more angled teeth 604 are sharp enough to pierce through an insulation part 606 of a cable 614 including the insulation part 606 and a conductor part 608, wherein the one or more angled teeth 604 are structured with a skinny body and a curved tip without compromising the ability of the one or more angled teeth 604 to pierce through the insulation part 606 of the cable 614 when proper force is applied, and wherein the one or more angled teeth 604 follow the voids 618 and/or slide in between the internal strands of the conducting part of the cable until they are partially or completely embedded in the stranding of the conductor part of the cable 608 to make an electrical connection 610 between the busbar 602 and the conductor part 608 of the cable 614 when in contact with the conductor part 608 of the cable 614.

Although, FIG. 6 illustrates internal strands of the conductor part of the cable as twisted, they may be straight as commercially the cables may be available in different configurations, and is also within the spirit and scope of the invention.

Although FIGS. 4 and 6 illustrate different embodiments, they may be implemented as separate embodiments or as a combination of one or more embodiments described herein.

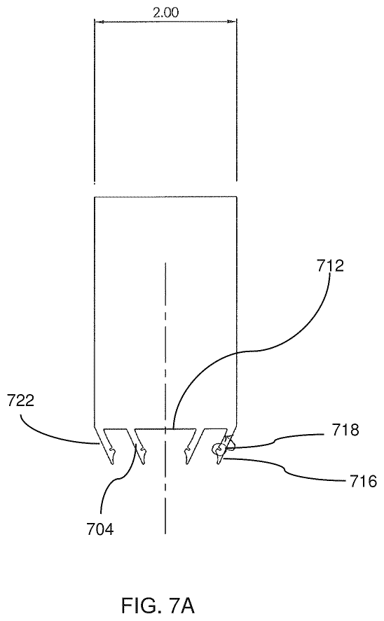

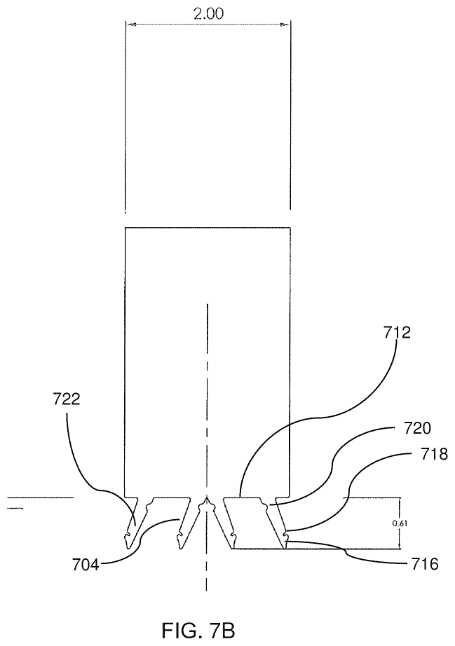

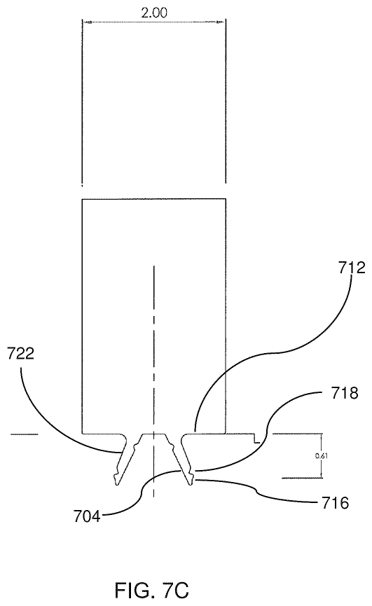

FIGS. 7A, 7B and 7C illustrate various configurations of the aligned insulation hooking busbar according to one or more embodiments described herein. For example, in one or more embodiments, the one or more angled teeth 704 may be provided with an additional notch 718 below the curve 716 as illustrated in FIG. 7A, whereas the curved tip 716 may be provided with an additional notch 718 below the curve and a second notch 720 on the skinny body 722 near the connection end 712 of the busbar as illustrated in FIG. 7B.

Additionally or alternatively, the angled teeth may be provided in different configurations including but not limited to a single tooth, two teeth as illustrated in FIG. 7C, four teeth as illustrated in FIGS. 7A and 7B, etc. and may be directed towards each other as illustrated in FIG. 7A or away from each other as illustrated in FIGS. 7B and 7C.

Different types of notches as well as combinations of the different types of notches illustrated in FIGS. 7A, 7B and 7C may allow the angled teeth to bend in different directions and thus facilitate the bending and sliding motion underneath the surface of the insulation layer, and/or sliding between the internal strands of the cable, and/or the one or more aligned teeth slide in between the internal strands of the conducting part of the cable until they are embedded in the conductor part of the cable without compromising the ability of the teeth to pierce through the insulation when proper force is applied. A person skilled in the art may readily recognize that although a few combinations are illustrated and described here, various other combinations are possible and are within the spirit and scope of this invention. Similarly, although some dimensions are illustrated in FIGS. 7A, 7B and 7C, busbars and angled teeth of other dimensions may be used based on the application and system requirements and such use is within the spirit and scope of this invention.

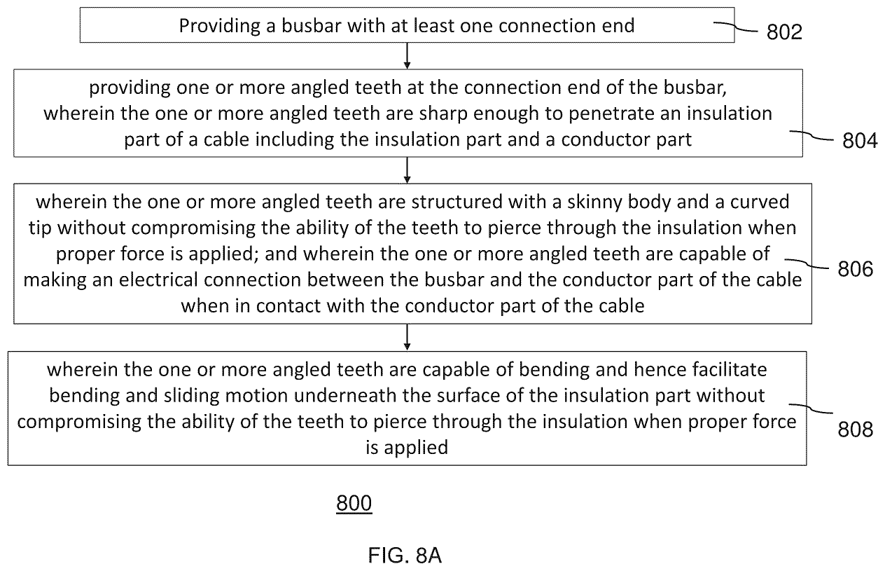

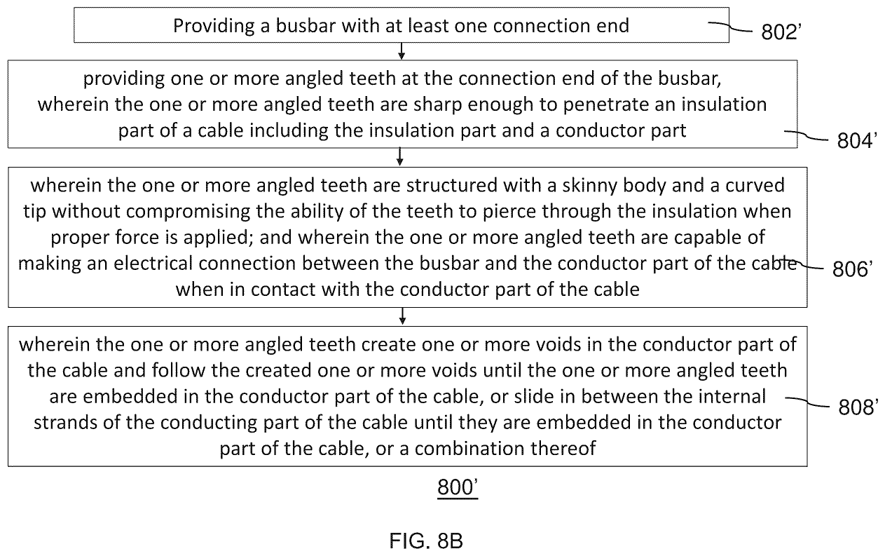

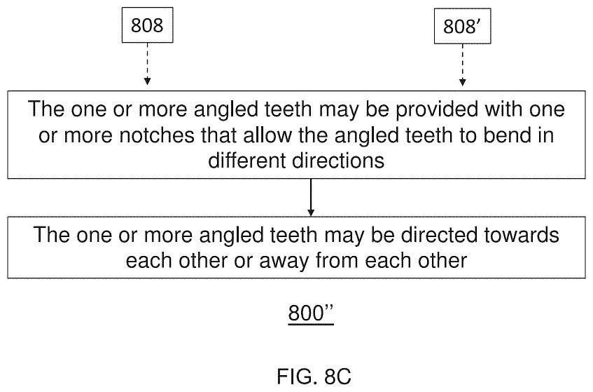

FIG. 8A illustrates an example method 800 for providing an aligned insulation hooking busbar according to one or more embodiments described herein. For example, the method for providing aligned insulation hooking busbar includes providing a busbar with at least one connection end via step 802; and providing one or more angled teeth at the connection end of the busbar via step 804, wherein the one or more angled teeth are sharp enough to penetrate an insulation part of a cable including the insulation part and a conductor part, wherein the one or more angled teeth are structured with a skinny body and a curved tip without compromising the ability of the teeth to pierce through the insulation when proper force is applied; and wherein the one or more angled teeth are capable of making an electrical connection between the busbar and the conductor part of the cable, 806.

The one or more angled teeth structured with a skinny body and a curved tip are capable of bending and hence facilitate bending and sliding motion of the angled teeth underneath the surface of the insulation part without compromising the ability of the teeth to pierce through the insulation when proper force is applied via step 808.

FIG. 8B illustrates an example method 600′ for providing an aligned insulation hooking busbar according to one or more embodiments described herein. For example, the method for providing aligned insulation hooking busbar includes providing a busbar with at least one connection end via step 802′; and providing one or more angled teeth at the connection end of the busbar via step 804′, wherein the one or more angled teeth are sharp enough to penetrate an insulation part of a cable including the insulation part and a conductor part, wherein the one or more angled teeth are structured with a skinny body and a curved tip without compromising the ability of the teeth to pierce through the insulation when proper force is applied; and wherein the one or more angled teeth are capable of making an electrical connection between the busbar and the conductor part of the cable, 806′.

As illustrated in FIG. 8B, in an embodiment, wherein the one or more angled teeth may create one or more voids in the conductor part of the cable and follow the created one or more voids until the one or more angled teeth are embedded in the conductor part of the cable, or slide in between the internal strands of the conducting part of the cable until they are embedded in the conductor part of the cable, or a combination thereof via step 808′.

Additionally or alternatively, in one or more embodiments, the teeth may push into the conductor strands via voids that may be created in the piercing motion. Thus, the hooking busbar angled teeth could slide either directly under the insulation material or migrate between the strands of the conductor part of the cable, either by creating voids or by sliding in between the strands of the conductor part of the cable or via combination of the different methods described here. In all circumstances, the electrical connection is created by this piercing action of the angled teeth and their interaction with the electrical conductor of the conductor part of the cable.

Additionally or alternatively, in any one or more of the embodiments described herein, one or more angled teeth may be provided with one or more notches that allow the angled teeth to bend in different directions via step 810 as illustrated in FIG. 8C.

Additionally or alternatively, in any one or more of the embodiments described herein, the one or more angled teeth may be directed towards or facing towards each other, or away from each other via step 812 as illustrated in FIG. 8C.

Although FIGS. 8A and 8B are illustrated as different embodiments, they may be implemented as separate embodiments or as a combination of the one or more embodiments described herein.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow.

As used herein the terms product, device, appliance, etc. are intended to be inclusive, interchangeable, and/or synonymous with one another and other similar equipment for purposes of the present invention though one will recognize that functionally each may have unique characteristics, functions and/or operations which may be specific to its individual capabilities.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

We claim:

1. An aligned insulation hooking busbar, comprising at least one connection end, wherein the at least one connection end further comprises one or more angled teeth,
wherein the one or more angled teeth are sharp enough to pierce through an insulation part of a cable including the insulation part and a conductor part,
wherein the one or more angled teeth are structured with a skinny body and a curved tip without compromising the ability of the one or more angled teeth to pierce through the insulation part of the cable when proper force is applied, and
wherein the one or more angled teeth make an electrical connection between the busbar and the conductor part of the cable when in contact with the conductor part of the cable.

2. The aligned insulation hooking busbar of claim 1, wherein the at least one connection end is made of an electrically conductive material.

3. The aligned insulation hooking busbar of claim 1, wherein the one or more angled teeth are made of an electrically conductive material.

4. The aligned insulation hooking busbar of claim 1, wherein the one or more angled teeth are capable of bending and sliding motion underneath the insulation part of the cable.

5. The aligned insulation hooking busbar of claim 1, wherein the one or more angled teeth: create one or more voids in the conductor part of the cable and follow the created one or more voids until the one or more angled teeth are embedded in the conductor part of the cable, or slide in between the internal strands of the conducting part of the cable until they are embedded in the conductor part of the cable, or a combination thereof.

6. The aligned insulation hooking busbar of claim 1, wherein the one or more angled teeth are provided with one or more notches that allow the angled teeth to bend in different directions.

7. The aligned insulation hooking busbar of claim 1, wherein the one or more angled teeth are directed towards each other or away from each other.

8. A method for providing aligned insulation hooking busbar, the method comprising:
providing a busbar with at least one connection end; and
providing one or more angled teeth at the connection end of the busbar,
wherein the one or more angled teeth are sharp enough to penetrate an insulation part of a cable including the insulation part and a conductor part,
wherein the one or more angled teeth are structured with a skinny body and a curved tip without compromising the ability of the teeth to pierce through the insulation when proper force is applied; and
wherein the one or more angled teeth are capable of making an electrical connection between the busbar and the conductor part of the cable.

9. The method of claim 8, wherein the at least one connection end is made of an electrically conductive material.

10. The method of claim 8, wherein the one or more angled teeth are made of an electrically conductive material.

11. The method of claim 8, wherein the one or more angled teeth are capable of bending and sliding motion underneath the surface of the insulation part without compromising the ability of the teeth to pierce through the insulation when proper force is applied.

12. The method of claim 8, wherein the one or more angled teeth are capable of any one or more of: creating one or more voids in the conductor part of the cable and following the created one or more voids by the one or more angled teeth until the one or more angled teeth are embedded in the conductor part of the cable and sliding in between the internal strands of the conducting part of the cable until they are embedded in the conductor part of the cable.

13. The method of claim 8, wherein the one or more angled teeth are provided with one or more notches that allow the angled teeth to bend in different directions.

14. The method of claim 8, wherein the one or more angled teeth are directed towards each other or away from each other.
